(19) United States
(12) Patent Application Publication
(10) Pub. No.: US 2003/0156730 A1
(43) Pub. Date: Aug. 21, 2003

(54) Structure of earphone hanger

(76) Inventor: Hsien-Ting Wu, Taoyuan (TW)

Correspondence Address: Keith Kline, PRO-TECHTOR INTERNATIONAL SERVICES, 20775 Norada Court, Saratoga, CA, 95070-3018, US

(21) Appl. No.: 10/074,459

(22) Filed: Feb. 11, 2002

(51) Int. Cl. H04R 25/00

(52) U.S. Cl. 381/381; 381/370; 381/374

(57) ABSTRACT

A structure of earphone hanger comprising: a connector on a base of an earphone, an arciform hanging rod connecting the connector, an elastic belt connecting both ends of the hanging rod, of which the elastic belt contacts the flesh surface of the root portion on the back side of an ear firmly but makes it feel cosy, the earphone is fixed in the hole of the ear. Wherein, the connector can allow the hanging rod and the earphone to pivotally adjust their angular positions in hanging on an ear, and can allow changing position of the hanging rod for hanging on the other ear of the person, and cosiness both in wearing on the left ear and the right ear can be increased.

### BACKGROUND OF THE INVENTION

1. Field of the Invention

The present invention relates to a structure of earphone hanger, and especially to an earphone hanger with improved firmness and cosiness when it is hung on an ear of a person, and being allowable of changing for hanging on the other ear of the person.

2. Description of the Prior Art

Science and technology progress with nonstop changing, especially in great prosperity of electronic communication products including computers, mobile phones, walkmans, PDA's (personal digital assistants) etc., the products have been widely used in all the globe. These electronic communication products all have sound receiving function, and thereby earphones with such sound receiving and playing function are necessary articles.

An earphone generally has therein a small horn enveloped with a soft net to be suitable for placing in an ear hole of a person, so that the horn can transmit the acoustic message to the ear.

The earphone products prevailing in the markets, for example, all tend to be earphones each for wearing on a single ear. They get the effect of reducing loading, but all along they have the problem of difficulty in fixing on an ear of a person.

Besides, relatively novel and improved earphones for wearing each on a single ear available nowadays have respectively a hanging rod which can be hung on the root portion on the back side of an ear to make its corresponding earphone hung in the ear hole. However, such an earphone for wearing on a single ear with a hanging rod is not suitable for long time wearing; although it is elastic, firmness as well as softness and cosiness are all insufficient, it will make discomfort of the root portion on the back side of the ear. When a conventional earphone is worn in an ear hole, it can not be lifted away to let air get into the ear hole, thereby, the sound waves from the earphone attack the inner ear drum for a long time, and acoustic nerves of the person may get fatigue. Improvement thereby is expected.

### SUMMARY OF THE INVENTION

The structure of earphone hanger of the present invention is designed in order to get improved firmness and cosiness when it is hung on an ear of a person, thereby, an object of long time wearing by a user can be achieved.

To get the above stated object, in practice, the earphone and its hanging rod must has therebetween a connector for connecting the hanging rod on the earphone, and the hanging rod is provided thereon with an elastic belt.

Wherein, the connector can allow the hanging rod and the earphone to pivotally adjust their angular positions in hanging on an ear, and can allow the horn of the earphone able to be lifted away from the ear hole; besides, the connector can allow changing position of the hanging rod for hanging on the other ear of the person, and cosiness both in wearing on the left ear and the right ear can be increased.

The elastic belt is soft and can stretch and contract elastically, it can support the hanging rod also provided with elasticity when in a tense state, and is put up onto the root portion on the back side of the ear; the elastic belt has a soft and comfortable contact surface, so that the flesh surface at the root portion on the back side of the ear can feel cosy when in contacting.

The present invention will be apparent after reading the detailed description of the preferred embodiment thereof in reference to the accompanying drawings.

### BRIEF DESCRIPTION OF THE DRAWINGS

FIG. 1 is a perspective view of the present invention;

FIG. 2 is an analytic perspective view of the present invention;

FIG. 3 is a partial sectional front view of the present invention;

FIG. 4 is a schematic view showing swiveling of a hanging rod of the present invention;

FIG. 5 is a sectional view showing a connector of the present invention;

FIG. 6 is a sectional view showing lifting of the connector with the earphone of the present invention;

FIG. 7 is a sectional view showing the hanging rod is mounted on the left side of the connector of the present invention;

FIG. 8 is a sectional view showing the hanging rod is mounted on the right side of the connector of the present invention;

FIG. 9 is a schematic view showing contact between an elastic belt and the back side of the ear of the present invention;

### DETAILED DESCRIPTION OF THE PREFERRED EMBODIMENT

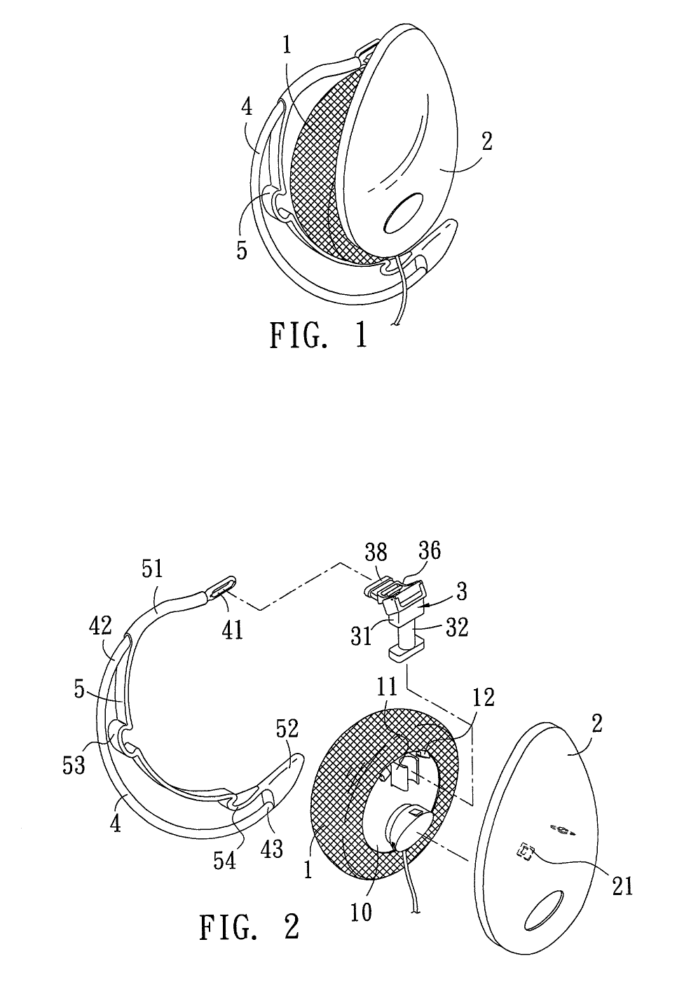

Referring to FIGS. 1 and 2 depicting the structure of earphone hanger of the present invention and its state of separating for analysis respectively, wherein, on a base 10 of an earphone 1 (having a small horn enveloped by a soft net), there are mounted a decorative cover 2, a connector 3, a hanging rod 4 which connects to the connector 3, and an elastic belt 5 provided on the hanging rod 4.

Wherein, the base 10 of the earphone 1 is provided with more than one hooks 12 and an axle bearing seat 11 (as shown in FIG. 2), the hooks 12 are used to assemble the decorative cover 2, and the axle bearing seat 11 is for pivotally connecting the connector 3.

The inner wall of the decorative cover 2 is provided at least with same number of engaging lugs 21 as that of the hooks 12, in order that the decorative cover 2 is firmly connected on the outer side of the base 10 of the earphone 1 (as shown in FIG. 1).

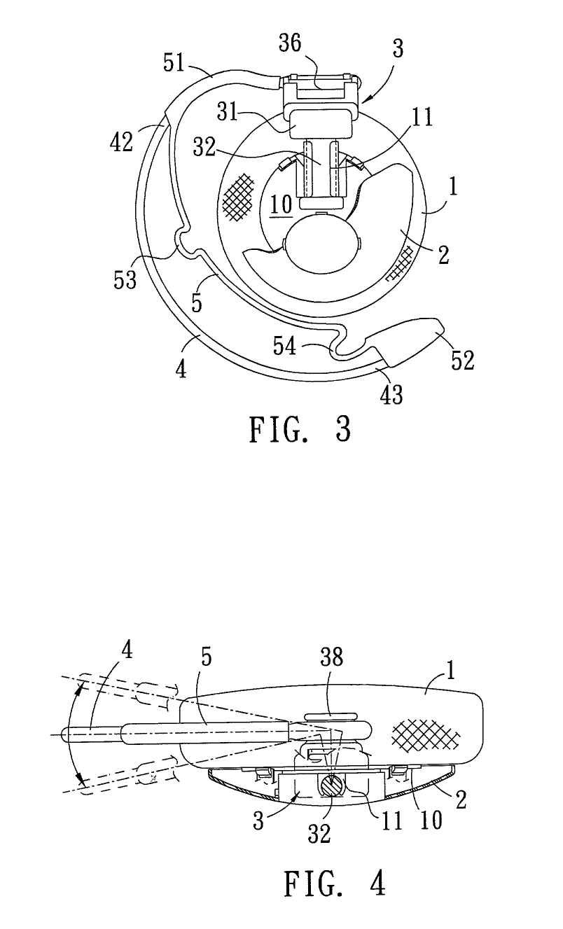

The connector 3 is formed by connecting a pivot-connecting seat 31 with an insertion-connecting seat 36 (as shown in FIG. 2). The pivot-connecting seat 31 is provided on one end thereof with a pivot axle 32 to be pivotally received in the axle bearing seat 11 (as shown in FIG. 3), so that the connector 3 can be swiveled on the base 10 of the earphone 1 to in turn render the hanging rod 4 connecting to the connector 3 to also be swiveled on the base 10 of the earphone 1 together with the connector 3 (as shown in FIG. 4). This is benefit to adjusting of angular hanging position on an ear for a coziest position.

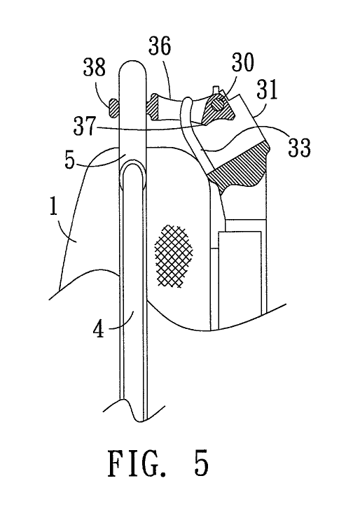

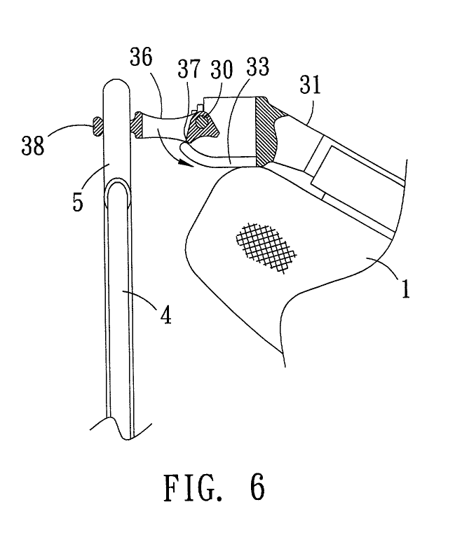

The insertion-connecting seat 36 and the pivot-connecting seat 31 have therebetween a pivot pin 30 for connection for swiveling (as shown in FIG. 5); and the pivot-connecting seat 31 is provided with a stop piece 33, the insertion-connecting seat 36 is provided with a protrusion 37, thereby, the pivot-connecting seat 31 and the earphone 1 connected therewith can be swiveled to lift for an angle on the insertion-connecting seat 36, and the protrusion 37 on the insertion-connecting seat 36 is used to stop the stop piece 33 on the pivot-connecting seat 31. Thereby, when the hanging rod 4 is hung on an ear of a person and positioned there, the earphone 1 can be allowed to be lifted (as shown in FIG. 6), in order that it gets away from the ear hole for a while to let air get in the ear hole for comfort.

The insertion-connecting seat 36 is provided on one end thereof with an insertion portion 38 (as shown in FIG. 2) to be used to connect the hanging rod 4.

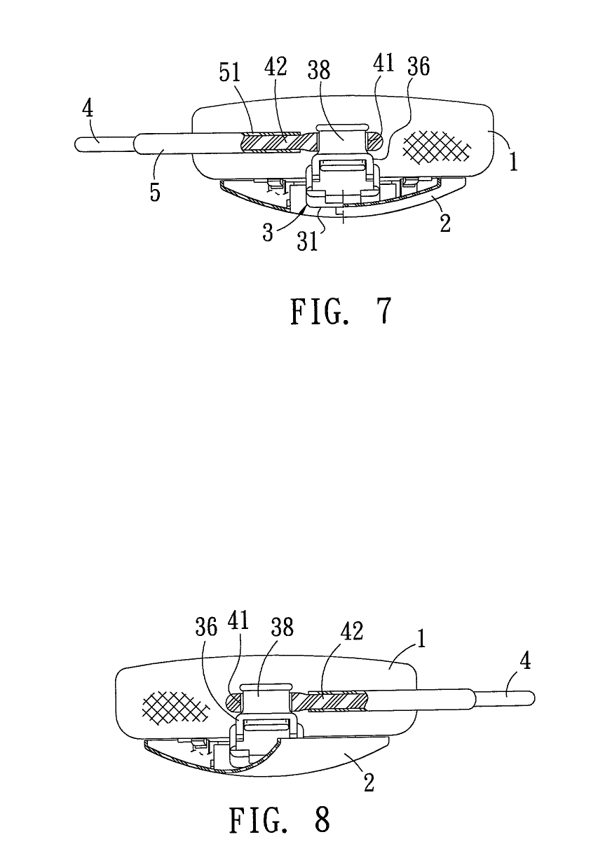

The hanging rod 4 is made from an elastic rod formed into an arciform shape (as shown in FIG. 2), and is formed on one end thereof an inserting hole 41 capable of engaging therein the insertion portion 38 of the insertion-connecting seat 36 (as shown in FIG. 7). Such design is benefit to changing of direction of the hanging rod 4 in mounting on the insertion portion 38 of the insertion-connecting seat 36. The hanging rod 4 as shown in FIG. 7 is connected on the left side of the insertion-connecting seat 36, while the hanging rod 4 shown in FIG. 7 is alternatively connected on the right side of the insertion-connecting seat 36, this is benefit to changing of hanging the earphone 1 on the left or the right ear of the person, thereby, the hanging rod 4 on the earphone 1 has an option to be mounted on the left or the right side of the earphone 1.

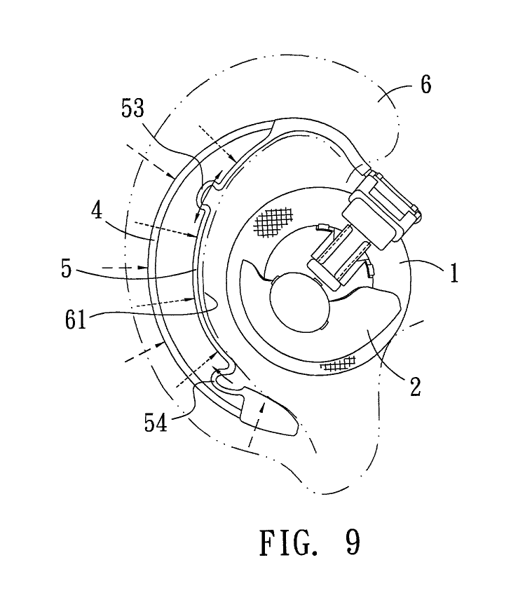

Moreover, the elastic belt 5 on the hanging rod 4 is made of excellent soft material, the elastic belt 5 has one end thereof made as a sleeve 51 which can be extended therethrough and can tightly bind about the head end 42 of the hanging rod 4 (as shown in FIG. 7). The other end of the elastic belt 5 is made as a sealed tip end 52 (as shown in FIG. 2) to envelop and fix the tailing end 43 of the hanging rod 4. And the shank of the elastic belt 5 is provided at least with one or more than one expansion portions 53, 54 (as shown in FIG. 9) in order that the elastic belt 5 has elastic stretching and contracting performance, it can support the hanging rod 4 also provided with elasticity when in a tense state. And when the hanging rod 4 is hung on an ear 6, the elastic belt 5 can softly contact the flesh surface of the root portion 61 on the back side of the ear 6, and binds firmly about the flesh surface by its elastic stretching and contracting performance. This helps firm hanging of the earphone 1 and the hanging rod 4 and endues the ear 6 with comfort.

In conclusion, the cited preferred embodiment of the present invention is not for limiting the present invention, so long a structure in which an elastic belt is provided on an earphone hanger and a pivotal connector is provided between the hanging rod and the base of the earphone to thereby provide firmness and comfort and capability of lifting the earphone and adjustment for angular position of the hanging rod and the earphone, the structure shall fall into the scope of the present invention.

Having thus described my invention, what I claim as new and desire to be secured by Letters Patent of the United States are:

1. A structure of earphone hanger comprising:
a connector on a base of an earphone, an arciform hanging rod connecting said connector, an elastic belt connecting both ends of said hanging rod, of which said elastic belt contacts the flesh surface of the root portion on the back side of an ear firmly but makes it feel cosy, said earphone is fixed in the hole of said ear.

2. A structure of earphone hanger as defined in claim 1, wherein,
said base of said earphone is provided with more than one hooks to assemble a decorative cover of which an inner wall is provided at least with same number of engaging lugs as that of said hooks

3. A structure of earphone hanger as defined in claim 1, wherein,
said base of said earphone is provided with an axle bearing seat for pivotally connecting said connector.

4. A structure of earphone hanger as defined in claim 1, wherein,
said connector is formed by connecting at least a pivot-connecting seat with an insertion-connecting seat, said pivot-connecting seat is connected with said base of said earphone, while said insertion-connecting seat is connected with said hanging rod.

5. A structure of earphone hanger as defined in claim 4, wherein,
said pivot-connecting seat is provided on one end thereof with a pivot axle to be pivotally received in said axle bearing seat on said base of said earphone.

6. A structure of earphone hanger as defined in claim 4, wherein,
said pivot-connecting seat is provided with a stop piece, said insertion-connecting seat is provided with a protrusion, thereby, said pivot-connecting seat and said earphone connected therewith are adapted to swiveling to lift for an angle on said insertion-connecting seat, and said protrusion on said insertion-connecting seat is used to stop said stop piece of said pivot-connecting seat at a lift position after said swiveling for positioning.

7. A structure of earphone hanger as defined in claim 4, wherein,
said insertion-connecting seat is provided on one end thereof with an insertion portion to be used to connect said hanging rod which is formed on one end thereof an inserting hole.

8. A structure of earphone hanger as defined in claim 1, wherein,
said elastic belt has one end thereof made as a sleeve to be extended therethrough and tightly bind about a head end of said hanging rod, the other end of said elastic belt is made as a sealed tip end to envelop and fix the tailing end of said hanging rod.

9. A structure of earphone hanger as defined in claim 1, wherein,
the shank of said elastic belt is provided with at least one or more than one expansion portions in order that said elastic belt has elastic stretching and contracting performance,
